(19) United States
(12) Patent Application Publication
(10) Pub. No.: US 2009/0072948 A1
(43) Pub. Date: Mar. 19, 2009

(54) ID Reading Device, ID Reading Method, ID Reading Program, and Inspection Device

(76) Inventors: Daisuke KOMAKI, Yokohama (JP); Hiroyuki Hamada, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/103,235

(22) Filed: Apr. 15, 2008

(30) Foreign Application Priority Data
Jun. 1, 2007 (JP) 2007-146434

(51) Int. Cl. H04Q 5/22

(52) U.S. Cl. 340/10.1

(57) ABSTRACT

An ID reading device in an ID reading system that acquires IDs from a reader that reads identification labels, comprises an expected ID acquisition unit that acquires IDs to be read; a read attribute acquisition unit that acquires a correspondence between read attributes and the IDs, the read attributes being classifications of articles based on a possibility that, there is actually an article to which the identification label is attached; a complement condition storage unit that stores a correspondence between complement conditions for complementing the IDs and the read attributes; and a complement unit that compares the IDs acquired by the expected ID acquisition unit with the IDs received by the reader for each of the read attributes where their correspondence is stored in a read attribute storage unit and complements the IDs acquired by the reader with the IDs acquired by the expected ID acquisition unit.

### INCORPORATION BY REFERENCE

The present application claims priority from Japanese application JP2007-146434 filed on Jun. 1, 2007, the content of which is hereby incorporated by reference into this application.

### BACKGROUND OF THE INVENTION

The present invention relates to an ID reading device that acquires an ID, which is an article identifier given to an identification label attached to an article, from a reader that reads the identification label and that complements an article ID that is actually present but cannot be acquired by the reader. The present invention related also to a method used for the ID reading device, an ID reading program used to implement the ID reading method, and an inspection device.

In a today's RFID (Radio Frequency Identification) system, an RFID to which an ID (hereinafter called an article ID) is given is attached to each item (hereinafter called an individual item) of goods, an article to which an RFID tag is attached is identified from an article ID that is read by an RFID reader, and predetermined processing is executed.

For example, JP-A-2006-160324 describes a distribution management system in which an article is managed by applying an RFID, and two-dimensional bar code containing the detailed contents is stuck to or directly printed on the package storing a plurality of the articles to manage the package (SOLUTION in the abstract of JP-A-2006-160324).

However, because the mechanism of an RFID is that an ID is read from a position several centimeters or several meters away using radio waves or electromagnetic waves, it is sometimes difficult to read an article ID given to an RFID tag when the RFID tag is hidden behind other articles or when an article on which the RFID tag is pasted has the property of absorbing electric waves or electromagnetic waves, for example, when the article is a metal or in the water.

Thus, if the expected receipt quantity matches the actual item quantity in a receipt inspection system and, under normal conditions, it should be determined that the inspection is passed, but if article IDs attached to some items cannot be read from RFID tags, the expected receipt quantity does not match the quantity calculated from the article IDs that have been read. As a result, the problem is that the receipt inspection system mistakenly determines that the inspection is rejected.

When packaged items are inspected, the probability with which an article ID given to an RFID tag can be read and the probability with which there is no item corresponding to an article ID depend on the location of the item in the package or the material of the item. The problem with the distribution management system disclosed in JP-A-2006-160324 is that the system does not consider those probabilities with the result that the items cannot be inspected efficiently.

### SUMMARY OF THE INVENTION

In view of the foregoing, it is an object of the present invention to appropriately complement an ID that was not read in a configuration in which an ID, which is given to an identification label such as an RFID tag attached to an article, is received from an identification label reader and, using the received unique information, the article to which the identification label is attached is identified and predetermined processing is executed.

It is another object of the present invention to appropriately inspect items using a simple method in a configuration in which an ID, which is given to an identification label such as an RFID tag attached to an article, is received from an identification label reader and, using the received unique information, the article to which the identification label is attached is identified and predetermined processing is executed.

An ID reading device according to the present invention for achieving at least one of the objects described above is used in an ID reading system that acquires IDs from a reader that reads identification labels, each of the IDs being an article identifier given to an identification label attached to an article. The ID reading device comprises an expected ID acquisition unit that acquires IDs to be read; a read attribute acquisition unit that acquires a correspondence between read attributes and the IDs, the read attributes being classifications of articles based on a possibility that, even if an identification label to which an ID is given cannot be read by the reader, there is actually an article to which the identification label is attached; a complement condition storage unit that stores a correspondence between complement conditions, each of which is a condition for complementing an ID, and the read attributes; and a complement unit that compares the IDs acquired by the expected ID acquisition unit with the IDs received by the reader for each of the read attributes and, if complement conditions defined in the complement condition storage unit and corresponding to the read attributes are satisfied, complements the IDs acquired by the reader with the IDs acquired by the expected ID acquisition unit.

The complement conditions may be specified by a ratio of the number of article IDs acquired by the expected ID acquisition unit to the number of article IDs received from the reader. The expected ID acquisition unit of the ID reading device may comprise a package information storage unit that stores the relation between articles and a package that includes those articles as the correspondence between article IDs and a package ID given to an identification label attached to the package; and a package solution unit that acquires the article IDs corresponding to a package ID, which is acquired by the reader, from the correspondence stored in the package information storage unit.

The read attribute may be information on the material of an article or on the position of an article in a package.

The ID reading device according to the present invention implemented by the operation of the processing units described above can be implemented by a computer program. This computer program is provided either by recording it in an appropriate recording medium such as a semiconductor memory or via a network and, when the present invention is executed, is installed for execution in a control unit such as the CPU for implementing the present invention.

The ID reading device according to the present invention configured as described above operates as follows. First, the expected ID acquisition unit acquires the article IDs that are expected to be read by an RFID reader. The article IDs are acquired from data, which includes the list of article IDs to be read, such as receipt schedule data or ASN(Advanced Shipping Notices). It is also possible to hold the relation between the items stored in a package material in advance and the package material as the correspondence between the article IDs (hereinafter called the article IDs of items) given to the RFID tags attached to the items and a package ID(hereinafter called the package ID of package material) given to the RFID tag attached to the package material, to read the package ID of the package material by the RFID reader, and to acquire the article IDs of the items stored in the package material, based on the correspondence, for the expected article IDs.

Next, the article IDs of the items are read by the RFID reader, the article IDs read by the RFID reader and the article IDs acquired by the expected ID acquisition unit are classified according to read attributes, and the rate between the number of article IDs acquired by the expected ID acquisition unit and the number of article IDs read by the RFID reader is calculated for each read attribute. If complement conditions pre-specified for the read attributes are satisfied, for example, if the calculated rate is higher than the minimum reading rate that is an example of complement conditions, the complement processing is performed in such a way that the article IDs read by the expected ID acquisition unit but not read by the RFID reader are added to the article IDS read by the RFID reader.

The read attributes are classifications of items based on a possibility that, even if an article ID acquired by the expected ID acquisition unit cannot be read by the RFID reader, there is actually an item to which an RFID tag, to which the article ID is given, is attached.

For example, when items are mounted on a distribution pallet, the items mounted inside are more difficult to be moved from the distribution pallet and so more difficult to be moved by a person in charge than the items mounted outside and, in addition, the article IDs of the items mounted inside are more difficult to be read than those of the items mounted outside. Therefore, there is a high possibility that the article ID of an item mounted inside, which cannot be read by the RFID reader, is an article ID that was acquired by the expected ID acquisition unit. In contrast, an item mounted outside is easily moved and its article ID is easily read and so, if the article ID cannot actually be read, there is a high possibility that there is no corresponding item. For this reason, the items mounted inside and items mounted outside are classified into separate read attributes. The correspondence between article IDs and read attributes is acquired in advance from the read attribute acquisition unit using an input device such as the keyboard.

To achieve at least one of the objects described above, an inspection device according to the present invention comprises an expected ID acquisition unit that acquires IDs to be read; a read attribute acquisition unit that acquires a correspondence between read attributes and the IDs, the read attributes being classifications of articles based on a possibility that, even if an identification label to which an ID is given cannot be read by the reader, there is actually an article to which the identification label is attached; an inspection pass standard acquisition unit that acquires a correspondence between the read attributes and inspection pass standards; and an inspection unit that compares the IDs acquired by the expected ID acquisition unit with the IDs received by the reader for each of the read attributes and, if standards corresponding to the read attribute acquired by the inspection pass standard acquisition unit are satisfied, determines that the inspection is passed.

The present invention allows the user to appropriately complement or inspect items even if there is an ID that cannot be read in a configuration in which an ID, which is given to an identification label such as an RFID tag attached to an article, is received from an identification label reader and, using the received unique information, the article to which the identification label is attached is identified and predetermined processing is executed.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the general configuration including an ID reading device in an embodiment of the present invention.

FIG. 2 is a flowchart showing the processing of an expected ID acquisition unit in the embodiment of the present invention.

FIG. 3 is a diagram showing a package information storage unit in the embodiment of the present invention.

FIG. 4 is a diagram showing a package ID read by an RFID reader in the embodiment of the present invention.

FIG. 5 is a diagram showing expected article IDs in the embodiment of the present invention.

FIG. 6 is a diagram showing a package information registration screen in the embodiment of the present invention.

FIG. 7 is a diagram showing a read attribute storage unit in the embodiment of the present invention.

FIG. 8 is a diagram showing items mounted on a palette in the embodiment of the present invention.

FIG. 9 is a diagram showing a complement condition storage unit in the embodiment of the present invention.

FIG. 10 is a diagram showing a read attribute registration screen in the embodiment of the present invention.

FIG. 11 is a flowchart showing the processing of a complement unit in the embodiment of the present invention.

FIG. 12 is a diagram showing a tabulation table in the embodiment of the present invention.

FIG. 13 is a diagram showing article IDs read by the RFID reader in the embodiment of the present invention.

FIG. 14 is a diagram showing a shipment inspection screen in the embodiment of the present invention.

FIG. 15 is a flowchart showing the processing of an inspection device in the embodiment of the present invention.

FIG. 16 is a diagram showing an individual item master in the embodiment of the present invention.

FIG. 17 is a diagram showing shipment instruction information in the embodiment of the present invention.

FIG. 18 is a diagram showing complemented article IDs in the embodiment of the present invention.

### DESCRIPTION OF THE INVENTION

An embodiment of the present invention will be described in detail with reference to the drawings.

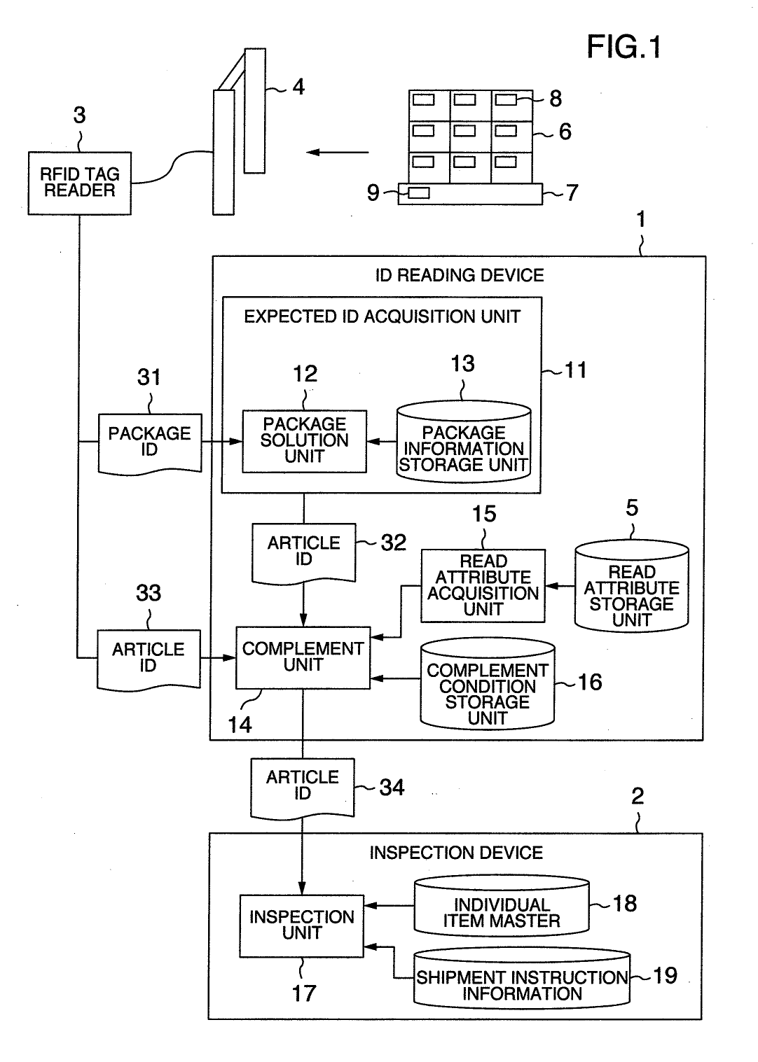

FIG. 1 is a diagram showing the general configuration of a system according to the present invention.

As shown in this figure, the system according to the present invention comprises an individual item RFID tag 8 to which an article ID is given and which is attached to an item 6, a package RFID tag 9 to which a package ID is given and which is attached to a package material 7, an RFID reader 3 and an antenna 4 that read an ID from the RFID tag of the individual item RFID tag 8 or the package RFID tag 9, an ID reading device 1, and a device that uses a complemented article ID according to the use of the complemented article ID. An example of the device that uses the complemented article ID is an inspection device 2 that may be a device used for not only inspection but also for performing other functions using the complemented article ID such as inventory, sorting, or picking.

Data can be sent and received between the ID reading device 1 and the RFID reader 3 via a cable or wirelessly.

The RFID reader 3 and the antenna 4 may be separate devices, connected via a network, or an integrated device.

The individual item RFID tag 8 and the package RFID tag 9 need not be an RFID tag but may be a device that issues an identification code wirelessly using electric waves, in which case the RFID reader 3 and the antenna 4 receive an identification code wirelessly from the device.

The ID reading device 1 and the inspection device 2 may also be a computer operating under program control. The ID reading device 1 and the inspection device 2 may be separate devices or computers as shown in FIG. 1 or may be combined into one device or computer. When the ID reading device 1 and the inspection device 2 are separate devices or computers, they are connected via a network.

When the ID reading device 1 or the inspection device 2 is a computer operating under program control, a package information storage unit 13, a read attribute storage unit 5, a complement condition storage unit 16, an individual item master 18, and shipment instruction information 19 are stored in the memory or in a secondary storage device such as an HDD. A package solution unit 12, a complement unit 14, and an inspection unit 17 are implemented by a program read into the memory for execution by the CPU. Those units can be implemented also by hardware, for example, by creating an integrated circuit that works as a processing unit for executing the corresponding processing.

To implement the present invention, the ID reading device 1 comprises an expected ID acquisition unit 11, a read attribute acquisition unit 15, the complement condition storage unit 16, and the complement unit 14.

First, the following describes the expected ID acquisition unit 11 with reference to FIG. 1 to FIG. 6.

The expected ID acquisition unit 11 acquires article IDs to be read by the RFID reader 3.

In one configuration of the expected ID acquisition unit 11 shown in FIG. 1, the expected ID acquisition unit 11 comprises the package information storage unit 13 that stores the packaging relation between the package material and the items in a form indicating the correspondence between the package ID of the package material and the article IDs of the items, and the package solution unit 12 that acquires a package ID read by the RFID reader and acquires the article IDs of the items, stored in the package material having the package ID, using the correspondence stored in the package information storage unit 13.

A package information registration screen 133 shown in FIG. 6 is an example of a registration unit used to register information in the package information storage unit 13.

The package ID of a package material is entered in a package ID entry box 134, and the article IDs of all items packaged by the package material with the package ID are entered in an article ID entry box 135, by means of an input unit such as a keyboard, and a registration button 136 is pressed to register the package information in the package information storage unit 13.

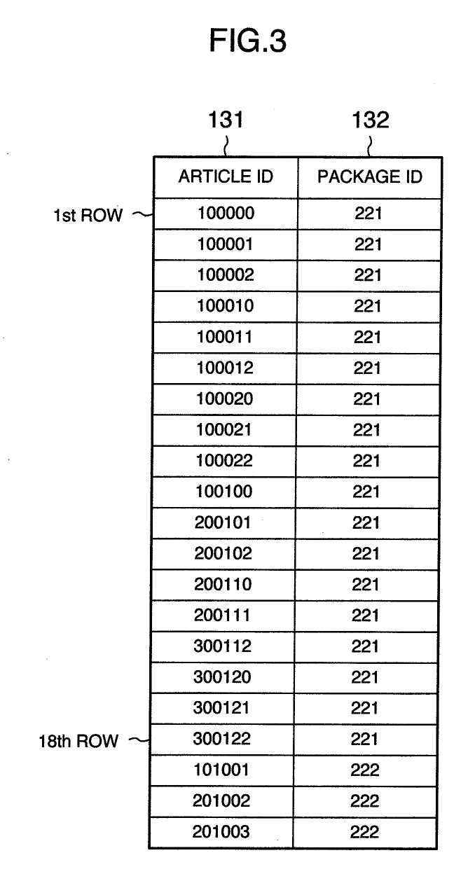

FIG. 3 is a diagram showing an example of the package information storage unit 13. For example, when the values are entered in the package ID entry box 134 and the article ID entry box 135 shown in FIG. 6 and the registration button 136 is pressed, the package information is registered as shown in the first row to the 18th row in FIG. 3.

The values entered in the package ID entry box 134 and the article ID entry box 135 may be the values read by the RFID reader or the bar code reader from a package RFID tag attached to the package material and RFID tags attached to the individual items which are packaged by the package material.

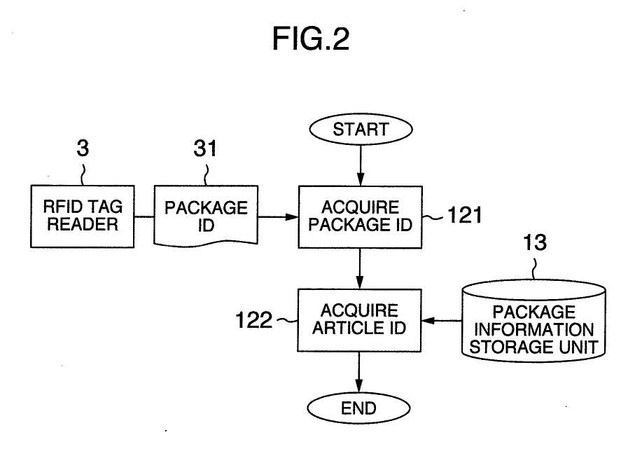

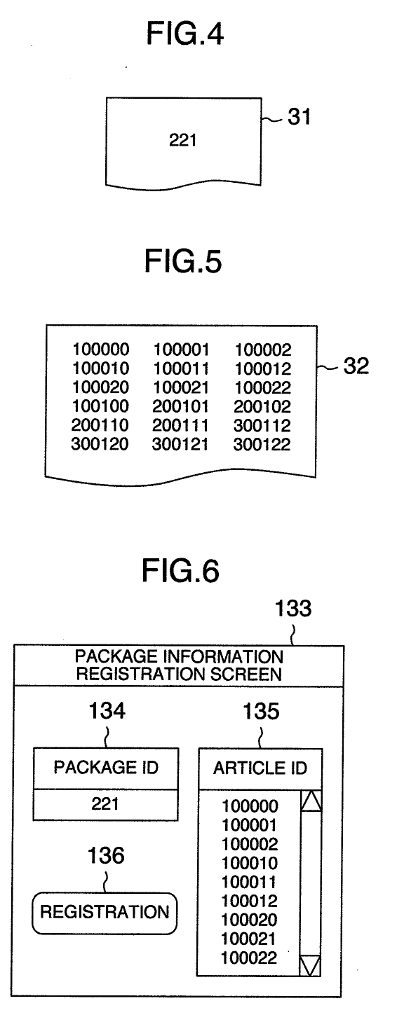

The following describes the processing executed by the package solution unit 12 with reference to the flowchart shown in FIG. 2, the package information storage unit 13 shown in FIG. 3, and a package ID 31 shown in FIG. 4.

First, in step 121, the package ID 31 read by the RFID reader 3 from the package RFID tag 9 is acquired. The package ID “221” is stored in the package ID 31 as shown in FIG. 4.

Next, in step 122, the article IDs of the items, stored in the package material to which the package ID 31 “221” is given, are acquired. More specifically, the values in an article ID column 131 of all rows whose package ID column 132 in the package information storage unit shown in FIG. 3 contains “221”, that is, the values of the article IDs 32 shown in FIG. 5, are output.

The expected ID acquisition unit 11 may acquire the expected article IDs based on the package relation by configuring the unit by the package information storage unit 13 and the package solution unit 12 as described above and acquire the expected article IDs using the package relation, or may acquire all article IDs, which are expected to be read by the RFID reader 3 at a receipt time, from the article IDs included in the scheduled receipt data or the ASN (Advanced Shipping Notice).

Next, the following describes the read attribute acquisition unit 15, read attribute storage unit 5, and the complement condition storage unit 16 with reference to FIG. 1 and FIG. 7 to FIG. 10.

The read attribute storage unit 5 stores classification data as the read attribute. This classification data indicates the possibility at which the item with an article ID is actually present when the article ID 32 is acquired by the expected ID acquisition unit 11 but cannot actually be read by the RFID reader 3.

The complement condition storage unit 16 stores data that indicates the minimum reading rate data as the complement condition for each read attribute acquired by the read attribute acquisition unit 15.

For example, the read attribute and the complement condition are related as follows. The reading rate of an RFID tag depends on the read attribute such as the material of an item, the position of an item, and the speed at which the RFID tag passes over the antenna. So, if an item with the article ID 32 which is acquired by the expected ID acquisition unit 11 but whose read attribute indicates a high reading rate cannot be read, there is a high possibility that the item is not actually present there. For this reason, the minimum reading rate is set high for the complement condition for the read attribute when the RFID tag of an item is easy to read. Conversely, the minimum reading rate is set low for the complement condition for the read attribute when the RFID tag of an item is difficult to read.

If the RFID tag attached to an item that is easy to move from the package cannot be read, there is a high possibility that the item is not actually there even if the article ID 32 of the item is acquired by the expected ID acquisition unit 11. For this reason, the minimum reading rate is set high for the complement condition for the read attribute when an item is easy to move from the package. Conversely, even if the RFID tag attached to an item that is difficult to move from the package cannot be read but if the article ID 32 of the item is acquired by the expected ID acquisition unit 11, there is a high possibility that the item is actually present there. For this reason, the minimum reading rate for the complement condition for the read attribute is set low when an item is difficult to move from the package.

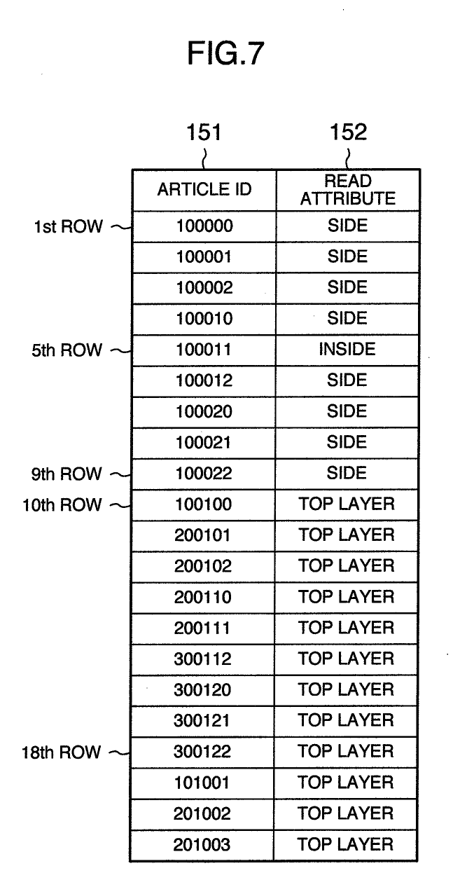

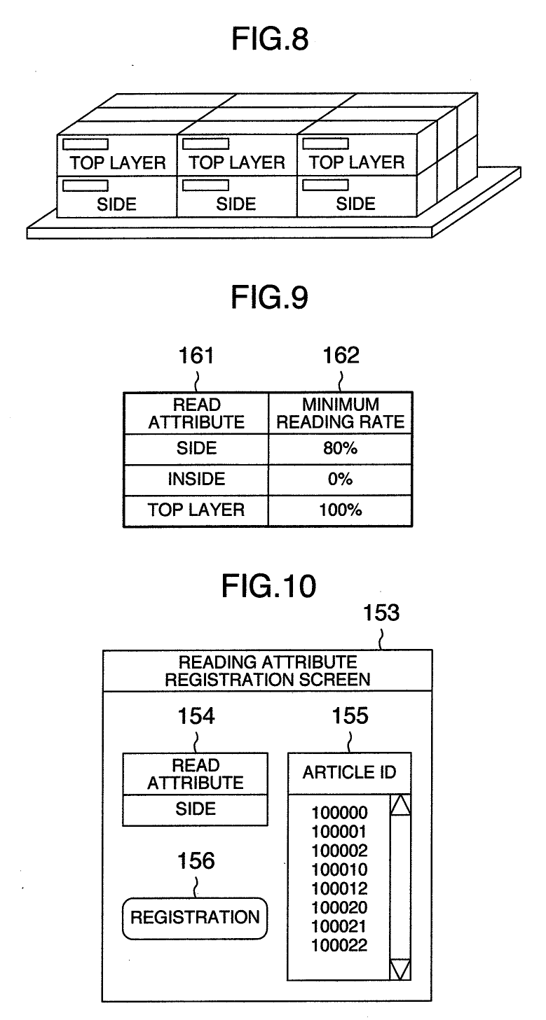

FIG. 8 is a diagram showing the items mounted on a pallet in three rows (width) of three items (depth) each, in two layers (height). FIG. 7 and FIG. 9 show an example of the setting of the read attribute storage unit 5 and the complement condition storage unit 16, respectively, of the items shown in FIG. 8. In this example, the read attribute refers to the position of an item.

An individual item RFID tag pasted on an item in the top layer in FIG. 8 is easy to read because nothing blocks the electric wave from the antenna 4 of the RFID reader 3. In addition, an item in the top layer tends to be moved because it sometimes drops from the pallet or is moved urgently somewhere else by a person in charge. Therefore, even if the item has the article ID 32 acquired by the expected ID acquisition unit 11, there is a high possibility that the item is not present there if the RFID tag cannot be read.

So, the read attribute columns 152 corresponding to the 10th row to the 18th row, in which an article ID column 151 contains the article IDs of the items in the top layer, are set to “top layer” in the read attribute storage unit 5 in FIG. 7, and the minimum reading rate of the read attribute “top layer” in the third row in the complement condition storage unit 16 in FIG. 9 is set to “100%”. Out of the items in the bottom layer in FIG. 8, the item in the center is surrounded at the top and sides by other items and, therefore, the individual RFID tag attached to that item is difficult to read. In addition, a person in charge who requires the item in the center finds it difficult to take it out.

Therefore, if the article ID 32 is acquired by the expected ID acquisition unit 11 but the RFID tag cannot be read, there is a high possibility that the item is actually in that position. So, the read attribute column 152 corresponding to the 5th row, in which the article ID column 151 contains the article ID of the item in the center of the bottom layer, is set to “inside” in the read attribute storage unit 5 in FIG. 7, and the minimum reading rate of the read attribute “inside” in the second row in the complement condition storage unit 16 in FIG. 9 is set low to “0%”.

The items in the bottom layer in FIG. 8, other than the one in the center, can be easily read because nothing blocks the electric wave from the antenna 4 of the RFID reader 3. In addition, a person in charge finds it somewhat difficult to take out those items when they are required. So, if the article ID 32s of those items are acquired by the expected ID acquisition unit 11 but if the RFID tags cannot be read, there is a rather high possibility that those items are actually not present there. For this reason, the read attribute columns 152 corresponding to the first row to the 9th row (except the fifth row), whose ID columns 151 contain the article IDs of the items in the bottom layer (except the item in the center), are set to “side” in the read attribute storage unit 5 in FIG. 7, and the minimum reading rate of the read attribute “side” is set high to “80%” in the first row in the complement condition storage unit 16 in FIG. 9.

A reading attribute registration screen 153 shown in FIG. 10 is an example of a registration unit for registering information in the read attribute storage unit 5. The article IDs of articles whose read attribute is to be set are entered in an article ID entry box 155, and a read attribute to be set is entered in a read attribute entry box 154, by means of an input unit such as a keyboard and, after that, a registration button 156 is pressed to store the entered data in the read attribute storage unit 5.

For example, when the registration button 156 is pressed with the values entered as shown in the article ID entry box 155 and the read attribute entry box 154 in FIG. 10, the data is registered in the first row to the 9th row (except the 5th row) in FIG. 7.

A value to be entered in the article ID entry box 155 may be a value read from the individual RFID tag of an item by an RFID reader or a bar code reader. The data in the complement condition storage unit 16 in FIG. 9 may be registered by the input unit in the same way as when data is registered in the read attribute storage unit 5 using the screen in FIG. 10 or may be prepared in advance as initial values.

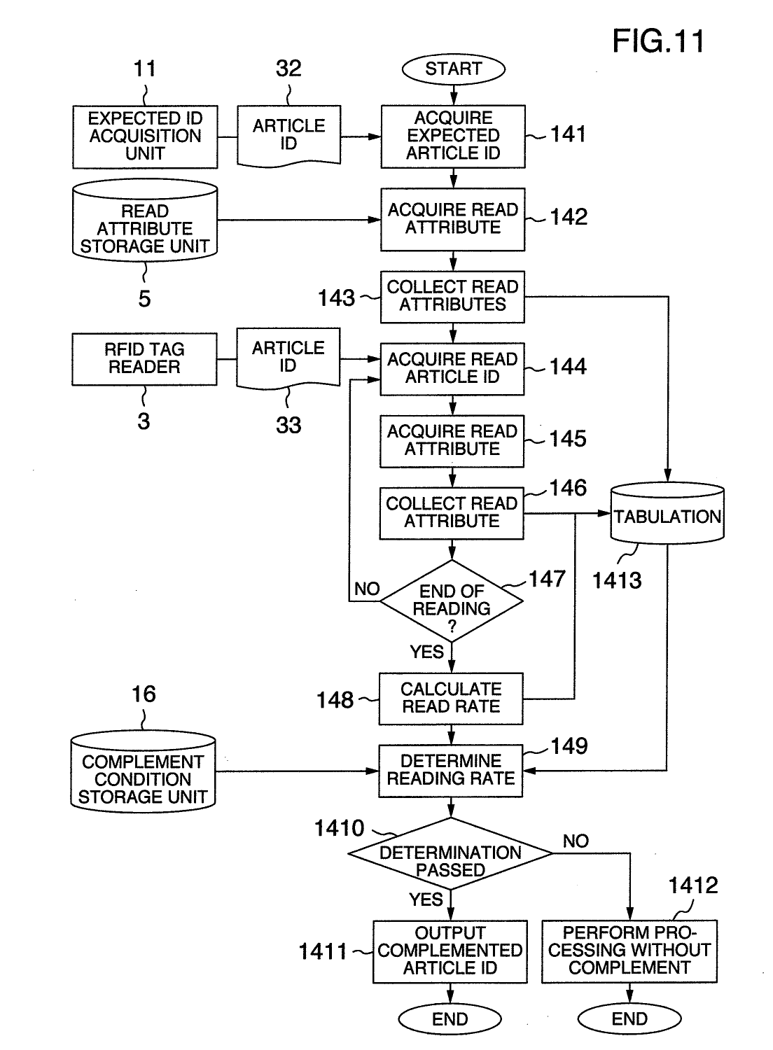

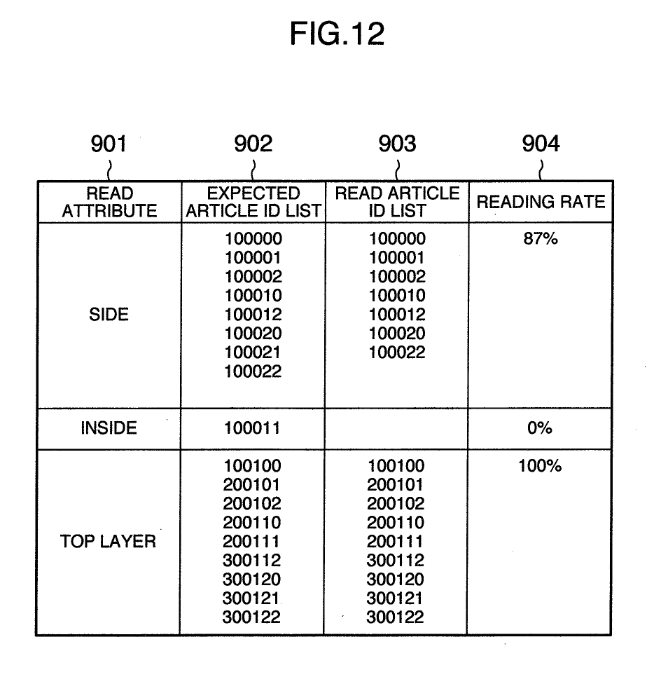

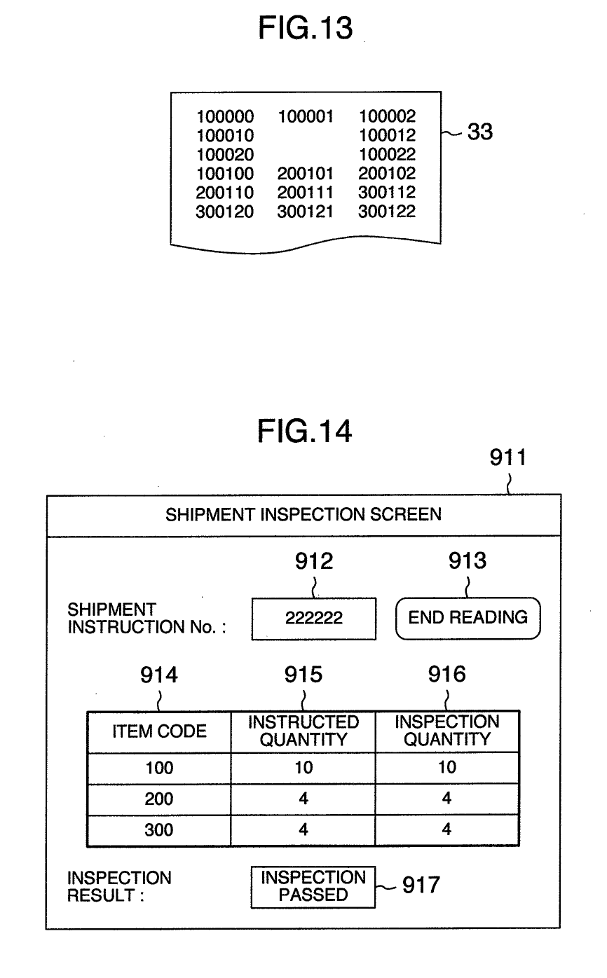

Next, the following describes the processing of the complement unit 14 with reference to the flowchart in FIG. 11, the read attribute storage unit 5 in FIG. 7, the complement condition storage unit 16 in FIG. 9, a tabulation table 1413 in FIG. 12 that is being prepared, the article IDs 32 in FIG. 5, and article IDs 33 in FIG. 13.

In step 141, the article IDs 32 shown in FIG. 5 are acquired form the expected ID acquisition unit 11.

In step 142, for each article ID included in the article IDs 32, the read attribute is acquired from the read attribute storage unit 5 in FIG. 7. The article IDs 32 in FIG. 5 correspond to the first row to the 18th row in FIG. 7.

In step 143, the article IDs 32 and their read attributes acquired in steps 141 and 142 are collected for each read attribute and saved in the tabulation table 1413. The values in a read attribute column 901 and an expected article ID column 902 of the tabulation table 1413 shown in FIG. 12 are those collected for the first row to the 18th row in FIG. 7 for each read attribute.

In step 144, the article IDs 33 read by the RFID reader 3 and shown in FIG. 13 are acquired. In step 145, the read attributes of the article IDs 33 are acquired from the read attribute storage unit 5 in FIG. 7. The article IDs 33 shown in FIG. 13 correspond to the first row to the 18th row (except the 8th row) in FIG. 7.

In step 146, the article IDs 33 and their read attributes acquired in steps 144 and 145 are collected for each read attribute and are saved in the tabulation table 1413. The read attribute column 901 and a read article ID column 903 in the tabulation table 1413 in FIG. 12 show the article IDs in the first row to the 18th row (except the 8th row) in FIG. 7 collected for each read attribute.

In step 147, a determination is made if the reading from the RFID reader 3 has ended. The determination is made by checking if a person in charge who recognizes the end of reading presses an End reading button 913 on a shipment inspection screen 911 in FIG. 14, which will be described later, and the person in charge has actually pressed the button, by checking if all article IDs 32 output from the expected ID acquisition unit 11 have been actually read, by checking if a predetermined time has elapsed from the time the first RFID tag was read, or by combining those conditions. If it is determined that the reading has been ended, control is passed to step 148; if it is determined that the reading has not been ended, control is passed back to step 144.

In step 148, the reading rate is calculated for each read attribute in the tabulation table 1413 shown in FIG. 12. More specifically, the number of article IDs in the read article ID column 903 is divided by the number of article IDs in the expected article ID column 902 for each read attribute to calculate the rate of article IDs that have been read, and the calculated rate is saved in a reading rate column 904.

In step 149, the value in the reading rate column 904 of the tabulation table 1413 in FIG. 12 is compared with the minimum reading rate stored in the complement condition storage unit 16 in FIG. 9 to determine if the complement condition is satisfied. In the examples in FIG. 12 and FIG. 9, the minimum reading rate is 80% and the reading rate is 87% for the read attribute “side”, the minimum reading rate is 0% and the reading rate is 0% for the read attribute “inside”, the minimum reading rate is 100% and the reading rate is 100% for the read attribute “top layer” and, so, the reading rate is equal to or higher than the minimum reading rate for all read attributes. Although the number of read article IDs is one less than the number of expected article IDs for the read attributes “side” and “inside”, it is determined that the complement conditions are satisfied.

In step 1410, if the complement conditions are satisfied in step 149, control is passed to step 1411; if not, control is passed to step 1412.

In step 1411, the article IDs 34 that are the same as the article IDs 32 output from the expected ID acquisition unit 11 are output.

In step 1412, control may be passed back to step 144 to restart reading from the RFID reader 3, the processing may be terminated with an error displayed on the screen, or the article IDs 33 that were actually read may be output.

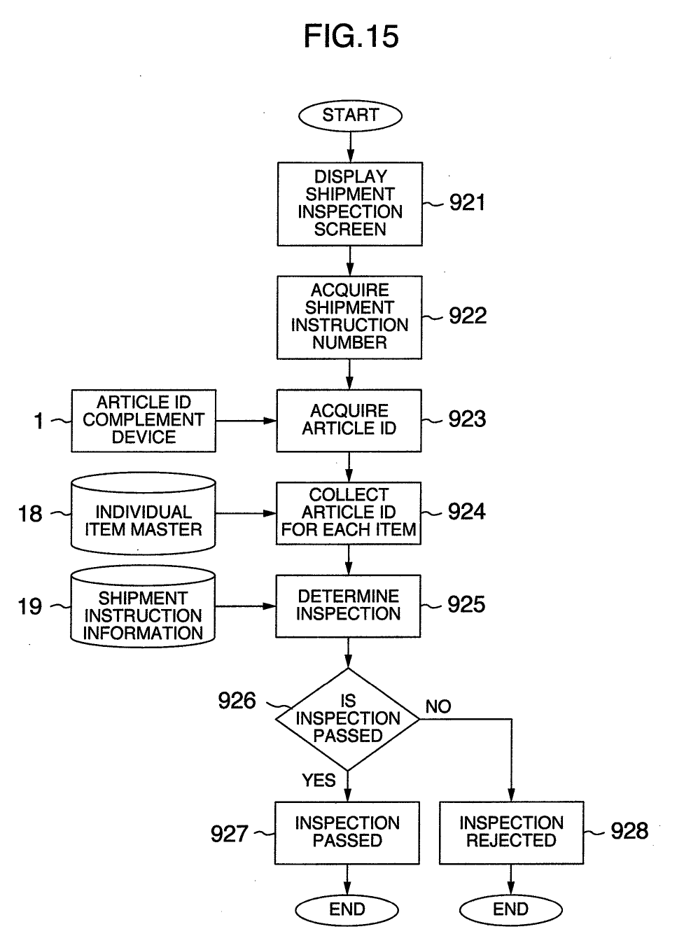

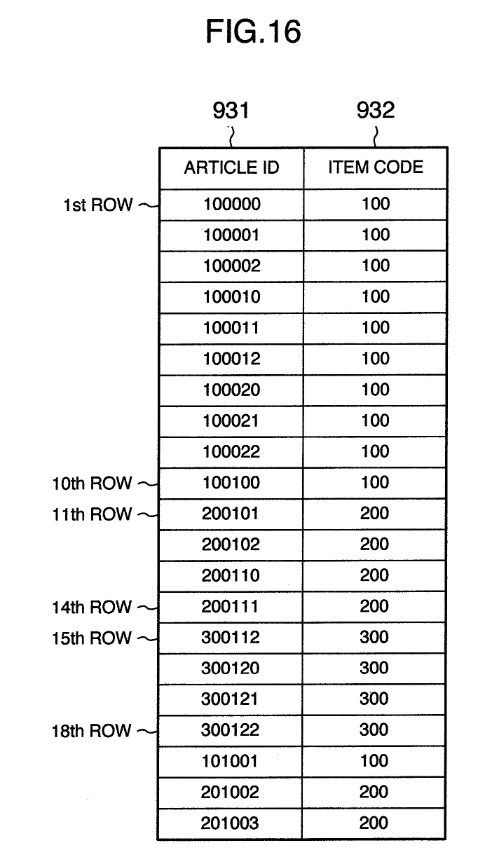

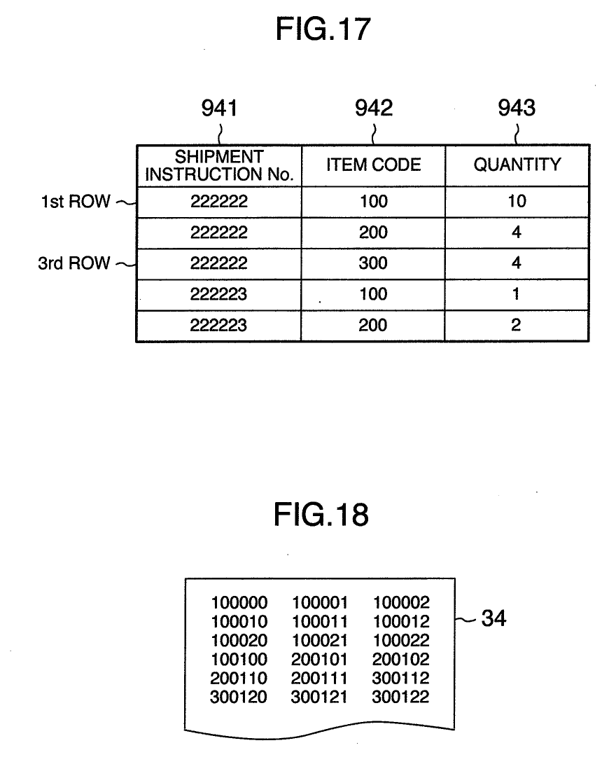

Next, the following describes the processing of the inspection unit 17, which constitutes the inspection device 2 that inspects the articles while using the article ID complement device 1 according to the present invention, with reference primarily to the flowchart of the inspection device in FIG. 15 and using the shipment inspection screen 911 in FIG. 14, the table of an individual item master 18 in FIG. 16, and the table of the shipment instruction information 19 in FIG. 17.

First, in step 921, the inspection device 2 displays the shipment inspection screen 911 shown in FIG. 14.

When this screen is displayed, a person in charge enters a shipment instruction number, which is an identification number for identifying an item to be inspected for shipment, in a shipment instruction number entry box 912 and reads the individual item RFID tags 8 of the items using the RFID reader 3. After the reading is ended, the End reading button 913 is pressed if it is necessary to press the button to determine the end of reading described in step 147 in FIG. 11. Pressing the End reading button 913 sends the entered information to the ID reading device 1.

In step 922, the shipment instruction number “222222”, entered in the shipment instruction number entry box 912 on the shipment inspection screen 911, is acquired.

In step 923, the article IDs 34 shown in FIG. 18 that are output from the ID reading device 1 are acquired.

In step 924, the article IDs 34 are collected for each item code using the individual item master 18 in which the correspondence between article IDs and item codes, shown in FIG. 16, are recorded. Because the article IDs of the article IDs 34 correspond to the first row to the 18th row, 10 items are collected for the item code “100”, four items are collected for the item code “200”, and four items are collected for the item code “300”. The collected information is displayed in an item code column 914 and an inspection quantity column 916 of the table on the shipment inspection screen 911 in FIG. 14.

In step 925, using the shipment instruction information 19 shown in FIG. 17, a determination is made if the quantity of each item code in the shipment instruction information matches the quantity of each item code collected in step 924. The shipment instruction number “222222” acquired in step 922 corresponds to the first row to the third row in the shipment instruction information 19 in FIG. 17, indicating that there are 10 items with the item code “100”, four items with the item code “200”, and four items with the item code “300”. Those values match the result collected in step 924 and, so, it is determined that the inspection is passed. If the quantities of at least one item code do not match between the two or if there is an item code included in one of the two but not in the other, it is determined that the inspection is rejected. The information in the first row to the third row in the shipment instruction information 19 is displayed in the item code column 914 and an instructed quantity column 915 in the table of the shipment inspection screen 911 in FIG. 14.

In step 926, if it is determined that the inspection is passed in step 925, control is passed to step 927; if it is determined that the inspection is rejected, control is passed to step 928.

In step 927, “Inspection passed” is displayed in an inspection result field 917 on the shipment inspection screen 911 in FIG. 14.

In step 928, “Inspection rejected” is displayed in the inspection result field 917 on the shipment inspection screen 911 in FIG. 14.

The ID reading device 1 and inspection device 2, though shown as separate devices in FIG. 1, may be combined into one device. In this case, instead of using the complement unit 14, the inspection unit 17 may determine if the inspection is passed or rejected based on the inspection passing requirement corresponding to the read attribute. Doing so eliminates the need for the complement processing and makes the processing simpler than in the example in FIG. 1 when it is only required to know if the inspection is passed or rejected.

The present invention is applicable to various systems each of which receives an ID, which is given to an identification label such as a bar code or an RFID tag attached to an article, from a reader that reads the identification label and, based on the received unique information, identifies the article to which the identification label is attached, and performs predetermined processing.

Examples of systems, to which the present invention is applicable, are a receipt inspection system, a shipment inspection system, and an inventory system in the distribution applications.

It should be further understood by those skilled in the art that although the foregoing description has been made on embodiments of the invention, the invention is not limited thereto and various changes and modifications may be made without departing from the spirit of the invention and the scope of the appended claims.

1. An ID reading device that acquires IDs from a reader that reads identification labels, each of said IDs being an article identifier given to an identification label attached to an article, said ID reading device comprising:
an expected ID acquisition unit that acquires IDs to be read;
a read attribute acquisition unit that acquires a correspondence between read attributes and the IDs, said read attributes being classifications of articles based on a possibility that, even if an identification label to which an ID is given cannot be read by said reader, there is actually an article to which the identification label is attached;
a complement condition storage unit that stores a correspondence between complement conditions, each of which is a condition for complementing an ID, and the read attributes; and
a complement unit that compares the IDs acquired by said expected ID acquisition unit with the IDs received by the reader for each of the read attributes and, if complement conditions defined in said complement condition storage unit and corresponding to the read attributes are satisfied, complements the IDs acquired by the reader with the IDs acquired by said expected ID acquisition unit.

2. The ID reading device according to claim 1 wherein the complement condition is indicated by a percentage at which the IDs acquired by said expected ID acquisition unit match the IDs read by said reader.

3. The ID reading device according to claim 1 wherein
said expected ID acquisition unit comprises:
a package information storage unit that stores a correspondence between a package ID, which is given to an identification label attached to a package including a plurality of articles, and IDs given to identification labels attached to the articles included in the package; and
a package solution unit that acquires IDs corresponding to a package ID acquired from said reader from the correspondence stored in said package information storage unit.

4. The ID reading device according to claim 1 wherein
the read attribute is information on a material of an article.

5. The ID reading device according to claim 1 wherein
the read attribute is a position of an article in a package.

6. An ID reading method that acquires IDs from a reader that reads identification labels, each of said IDs being an article identifier given to an identification label attached to an article, said ID reading method comprising:
an expected ID acquisition step of acquiring IDs to be read;
a read attribute acquisition step of acquiring a correspondence between read attributes and the IDs, said read attributes being classifications of articles based on a possibility that, even if an identification label to which an ID is given cannot be read by said reader, there is actually an article to which the identification label is attached;
a complement condition storage step of storing a correspondence between complement conditions, each of which is a condition for complementing an ID, and the read attributes; and
a complement step of comparing the IDs acquired by said expected ID acquisition step with the IDs received by the reader for each of the read attributes and, if complement conditions defined in said complement condition storage step and corresponding to the read attribute are satisfied, complementing the IDs acquired by the reader with the IDs acquired by said expected ID acquisition step.

7. The ID reading method according to claim 6 wherein the complement condition is indicated by a percentage at which the IDs acquired by said expected ID acquisition step match the IDs read by said reader.

8. The ID reading method according to claim 6 wherein
said expected ID acquisition step comprises:
a package information storage step of storing a correspondence between a package ID, which is given to an identification label attached to a package including a plurality of articles, and IDs given to identification labels attached to the articles included in the package; and
a package solution step of acquiring IDs corresponding to a package ID acquired from said reader from the correspondence stored in said package information storage step.

9. The ID reading method according to claim 6 wherein
the read attribute is information on a material of an article.

10. The ID reading method according to claim 6 wherein
the read attribute is a position of an article in a package.

11. An ID reading program stored in a computer executable storage medium for executing processing used for implementing the ID reading method according to claim 6.

12. An inspection device that acquires IDs from a reader that reads identification labels, each of said IDs being an article identifier given to an identification label attached to an article, said inspection device comprising:
an expected ID acquisition unit that acquires IDs to be read;
a read attribute acquisition unit that acquires a correspondence between read attributes and the IDs, said read attributes being classifications of articles based on a possibility that, even if an identification label to which an ID is given cannot be read by said reader, there is actually an article to which the identification label is attached;
an inspection pass standard acquisition unit that acquires a correspondence between the read attributes and inspection pass standards; and
an inspection unit that compares the IDs acquired by said expected ID acquisition unit with the IDs received by the reader for each of the read attributes and, if standards corresponding to the read attribute acquired by said inspection pass standard acquisition unit are satisfied, determines that the inspection is passed.

13. The inspection device according to claim 12 wherein the complement condition is indicated by a percentage at which the IDs acquired by said expected ID acquisition unit match the IDs read by said reader.

14. The inspection device according to claim 12 wherein
said expected ID acquisition unit comprises:
a package information storage unit that stores a correspondence between a package ID, which is given to an identification label attached to a package including a plurality of articles, and IDs given to identification labels attached to the articles included in the package; and
a package solution unit that acquires IDs corresponding to a package ID acquired from said reader from the correspondence stored in said package information storage unit.

15. The inspection device according to claim 12 wherein
the read attribute is information on a material of an article.

16. The inspection device according to claim 12 wherein
the read attribute is a position of an article in a package.
